(19) United States
(12) Patent Application Publication
(10) Pub. No.: US 2014/0010156 A1
(43) Pub. Date: Jan. 9, 2014

(54) Method and Wireless Device for Antenna Selection

(71) Applicant: MEDIATEK INC., Hsin-Chu (TW)

(72) Inventors: Wei-Ping Chuang, Kaohsiung City (TW); Hai-Pin Liang, Taipei City (TW); Tsung-Hsuan Wu, Changhua County (TW)

(21) Appl. No.: 13/936,206

(22) Filed: Jul. 7, 2013

Related U.S. Application Data
(60) Provisional application No. 61/668,610, filed on Jul. 6, 2012.

(51) Int. Cl. H04W 88/08

(52) U.S. Cl. CPC H04W 88/08
USPC 370/328

(57) ABSTRACT

A transmission method for a wireless device is disclosed. The wireless device has a plurality of antennas. The transmission method includes determining a first set of the plurality of antennas, determining a second set of the plurality of antennas, transmitting a packet to a first client using the first set of the plurality of antennas; and transmitting a packet to a second client using the second set of the plurality of antennas.

### CROSS REFERENCE TO RELATED APPLICATIONS

This application claims the benefit of U.S. provisional application No. 61/668,610, filed on Jul. 6, 2012 and incorporated herein by reference.

### BACKGROUND

The present disclosure relates generally to communication, and more specifically to antenna selection during transmission and reception in a wireless communication network.

A wireless communication network may include an access point and many stations. Each station may be located anywhere within the wireless network. An access point usually uses one or more omni antennas to transmit or receive data from all the stations. However, conventional access point has to determine which one or more antennas should be use each time data is determined to transmit to a certain station, which reduces the efficiency of the wireless network.

There is therefore a need in the art for techniques to improve performance of data transmission and reception in a wireless communication network.

### SUMMARY

Therefore, the primary objective of the present invention is to provide a method and a wireless communication device for determining which antenna should be used for transmission and reception.

The present invention discloses a method for a wireless device, wherein the wireless device comprises a plurality of antennas, the method comprising, determining a first set of the plurality of antennas, determining a second set of the plurality of antennas, transmitting a packet to a first client using the first set of the plurality of antennas, and transmitting a packet to a second client using the second set of the plurality of antennas.

The present invention further discloses a wireless device, comprising a plurality of antennas, a memory for storing a first set of the plurality of antennas and a second set of the plurality of antennas, and a processor coupled to the memory for switching to the first set of the plurality of antennas to transmit a packet to the first client and switching to the second set of the plurality of antennas to transmit a packet to the second client.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication device according to an embodiment of the invention.

FIG. 2 illustrates a possible architecture of the wireless device according to an embodiment of the invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in sub-module. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

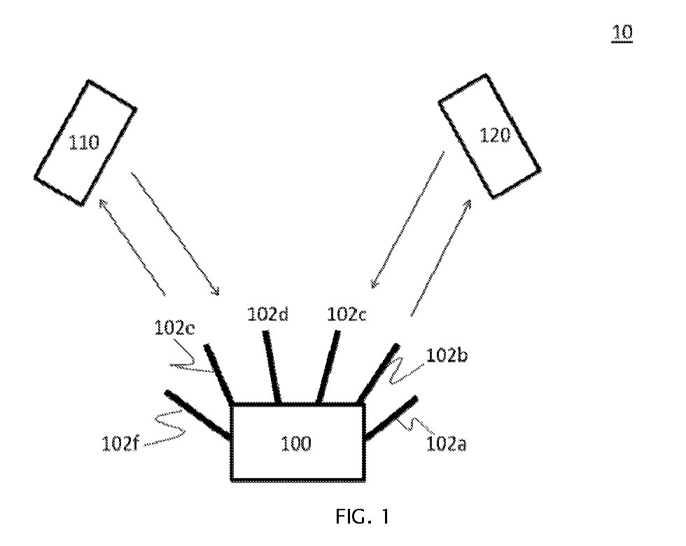

Please refer to FIG. 1, which is a schematic diagram of the wireless communication system 10 according to an embodiment of the invention. The wireless communication system 10 includes a wireless device 100, a first client 110 and a second device 120. The wireless device 100 can be an access point (AP) commonly used in wireless local area network (WLAN) or a station with software AP function. The wireless device 100 includes a plurality of antennas 102a-102f. The first client 110 and the second client 120 can be a station commonly used in WLAN or another AP. Noticeably, the embodiment of the invention demonstrates examples with six antennas, and those skilled in the art can adaptively modify the number of the antennas for different requirements. In simple, the embodiments of the invention hereinafter will discuss the cases with six antennas 102a-102f in the following paragraphs, which is not limiting the scope of the invention. In addition, the antennas 102a-102f may be directional antennas or at least one of the antennas 102a-102f may be an omni-directional antenna.

### 1. Training Process

Please refer to the wireless communication system in FIG. 1. The wireless device 100 first needs to determine how to communicate with the clients 110 and 120. According to an embodiment of the present invention, the wireless device 100 sends a plurality of channel check packets (CCP) to the first client 110. After receiving the CCPs, the first client 110 responds with channel response packets (CRP). Please note that CCP can be a quality of service (QoS) null type packet, and CRP can be a normal acknowledgement (ACK) type packet. The wireless device 100 get received signal strength indicator (RSSI) and other signal information from the CRPs. According to the RSSI, the wireless device 100 may estimate possible modulation and coding scheme (MCS) and payload length of CCP that can be used for further antenna selection. However, those skilled in the art will appreciate that there are other methods that can be used to estimate the possible MCS for transmission between the wireless device and the first client. And the present invention is not limited to the method mentioned above.

Afterwards, the wireless device 100 selects one of the antennas, 102e for example, to send CCP to associate the first client 110 then waits for the corresponding response. If no response is received, wireless device 100 will keep MCS auto fall back until the corresponding CRP is received successfully. Therefore, the total retry count of the CCP is recorded for antenna 102e. This procedure is repeated for all the antennas 102a-102f. Also, this procedure is performed for different combinations of the antennas, for example but not limited to, using antennas 102e and 102f together, or using antennas 102f, 102c and 102a. The retry counts for all each antenna and different combinations are recorded, the wireless device 100 thus may choose a best antenna set for the first client 110, for example the antenna or combination with least retry count. Further, the antenna set for the first client 110 may comprise a plurality of directional antennas or a combination of an omni-directional antenna and a directional antenna.

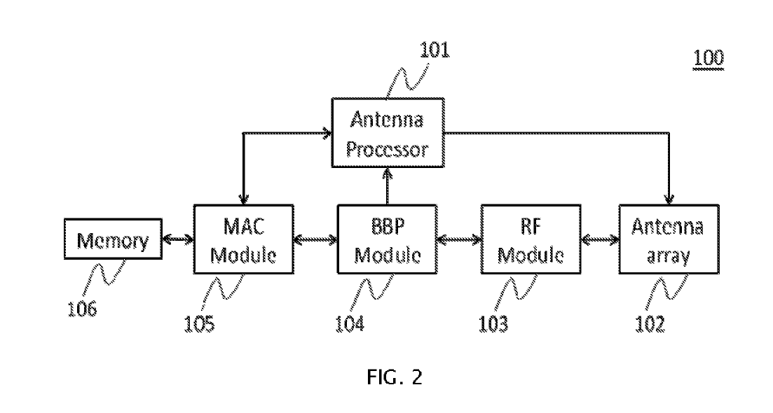

Then, the similar process is performed again for client 2. And the retry counts for all each antenna and different combinations are recorded, the wireless device 100 thus may choose a best antenna set for the second client 120. The antenna set for the second client 120 may comprise a plurality of directional antennas or a combination of an omni-directional antenna and a directional antenna. The antenna sets for the first client 110 and the second client 120 may overlap and does not have to be absolutely different. These results are then stored in a memory 106 in wireless device 100, as shown in FIG. 2.

### 2. Transmission

Now please refer to FIG. 2, which illustrates a possible architecture of the wireless device 100. The wireless device 100 includes an antenna array 102, which includes the antennas 102a-102g, a radio frequency (RF) module 103, a baseband processing module (BBP) 104, a medium access control module (MAC) 105, a memory 106, and an antenna processor 101. The processor 101 can be used to control which antenna set should be used for transmission according to the data stored in the memory 106. Please note that the antenna processor 101 can be a integrated into the BBP module 104 or the MAC module 105. The illustration is provided as an example and the present invention is therefore not limited to it.

According to an embodiment of the present invention, if the wireless device 100 has a first packet to the client 110 and a second packet to the client 120, the antenna processor 101 first gets information from the MAC module 105 that there's a packet for client 110. The antenna processor 110 notifies the antenna array 102 about the antenna set should be used. Hence, the antenna array 102 uses the antenna set obtained from the training process to transmit the first packet to the first client 110. The antenna processor 110 may then notifies the antenna array 102 to switch to the antenna set for the second client 120 and therefore the antenna array 102 may use it to transmit the second packet to the client 120.

By doing so, the wireless device 100 is capable to use the best antenna set for transmission on a per packet base. In addition the wireless device may also use the best antenna set for receiving the ACK from the first client 110 and the second client 120 until time out.

### 3. Reception

If the first client 110 has a packet to transmit to the wireless device 100, the client 110 will send a clear-to-send (CTS) or request-to-send (RTS) packet to notify the wireless devices in the neighborhood. Upon receiving this packet, the antenna processor 101 of the wireless device 100 can instruct the antenna array 102 switch to the antenna set for the first client 110 to receive the packet from the first client 110. It is because that the channel between the wireless device 100 and the first client 110 is assumed to be steady and therefore the best antenna set for transmission should be the best antenna for reception.

However, if the reception is failed or if the wireless device 100 is intended to listen to other clients, the wireless device 100 may switch to an omni-directional antenna or omni-directional antenna set to extend the coverage to un-associated clients. According to another embodiment of the present invention, the wireless device 100 may also use an Optimal Antenna Set that is optimal for all associated clients. This helps to enhance the receiving capability to all associated clients, because the wireless device 100 is uncertain which associate client will transmit a data packet

To sum up, according to the methods disclosed in the invention, a wireless communication device can determine an antenna set best for transmission and reception, which is efficient and cost-effective.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for a wireless device, wherein the wireless device comprises a plurality of antennas, the method comprising,
determining a first set of the plurality of antennas;
determining a second set of the plurality of antennas;
transmitting a packet to a first client using the first set of the plurality of antennas; and
transmitting a packet to a second client using the second set of the plurality of antennas.

2. The method of claim 1, further comprising,
receiving a packet from the first client using the first set of the plurality of antennas.

3. The method of claim 1, further comprising,
receiving a packet from the second client using the second set of the plurality of antennas.

4. The method of claim 1, wherein the first set of the plurality of antennas is determined by a transmission quality between the wireless device and the first client.

5. The method of claim 4, wherein the transmission quality is determined by a retry count between the wireless device and the first client.

6. The method of claim 1, wherein at least one of the first set of the plurality of antennas and the second set of the plurality of antennas comprises at a directional antenna.

7. The method of claim 1, wherein at least one of the first set of the plurality of antennas and the second set of the plurality of antennas comprises an omni-directional antenna and a directional antenna.

8. The method of claim 1, further comprising,
switching to an omni-directional antenna of the plurality of antennas; and
receiving a packet from other clients with the omni-directional antenna.

9. The method of claim 1, further comprising,
receiving a request from the first client; and
switching to the first set of the plurality of antennas.

10. The method of claim 1, wherein the step of determining the first set of the plurality of antennas comprises,
transmitting a plurality of null packets through each of the plurality of antennas to the first client;
generating an index according to a plurality of received packets in response to the plurality of null packets transmitted by each antenna; and
determining the first set of the plurality of antennas according to the index.

11. A wireless device, comprising,
a plurality of antennas;
a memory for storing a first set of the plurality of antennas and a second set of the plurality of antennas; and
a processor coupled to the memory for switching to the first set of the plurality of antennas to transmit a packet to the first client and switching to the second set of the plurality of antennas to transmit a packet to the second client.

12. The wireless device of claim 11, wherein the plurality of antennas comprise at least one omni directional antenna and at least one directional antenna.

13. The wireless device of claim 12, wherein the processor switches to the omni directional antenna for receiving packets.
